(19) United States
(12) Patent Application Publication
(10) Pub. No.: US 2010/0223417 A1
(43) Pub. Date: Sep. 2, 2010

(54) SWITCH FOR TRANSFERRING A FILE BETWEEN ASSOCIATED COMPUTERS

(75) Inventor: Ching-Wei Cheng, Keelung (TW)

Correspondence Address: ROGER H. CHU, 19499 ERIC DRIVE, SARATOGA, CA, 95070, US

(73) Assignee: ACTION STAR ENTERPRISE CO., LTD., Sijhih (TW)

(21) Appl. No.: 12/713,174

(22) Filed: Feb. 26, 2010

Related U.S. Application Data
(60) Provisional application No. 61/155,931, filed on Feb. 27, 2009.

(51) Int. Cl. G06F 13/00

(52) U.S. Cl. 710/316

(57) ABSTRACT

A switch for transferring a file between associated computers comprises a first port set coupled a first computer; a second port set coupled to a second computer; a third port set coupled to the first and second computer; a first hub coupled to the first port set; a second hub coupled to the second port set; a data transferring unit coupled between the first hub and the second hub; a driving unit coupled to the first hub and the second hub and stored driving programs; a switching unit coupled to the first hub, second hub and the third port set; a control port set coupled to the switching unit; and a set of a keyboard, a cursor control device and a display unit coupled to the control port set; wherein the switching unit switches the set of keyboard, the cursor control device and the display unit coupled from the first computer to the second computer; wherein the data transferring unit registers a file from the first computer through the first hub and then transfers the file to the second computer through the second hub.

### CROSS REFERENCE TO RELATED APPLICATIONS

This application claims priority from a co-pending U.S. Provisional Patent Application Ser. No. 61/155,931, filed Feb. 27, 2009, the entire content of which is incorporated herein by reference.

### BACKGROUND OF THE INVENTION

1. Field of the Invention

The present invention generally relates to a switch for controlling a plurality of computers, and more particularly, to a switch for transferring a file between associated computers.

2. Description of the Prior Art

There exist devices for interconnecting a single computer to multiple computers. For example, a keyboard/video/cursor control device (KVM) switch is a device that is generally connected to multiple computers in order to enable a single keyboard, video monitor and cursor control device to control each of the connected computers. In this way, a user may have access to multiple computers without having to invest in corresponding keyboards, monitors, and mice for each of the computers. When the user accesses a computer connected to the KVM switch, video signals are routed from the computer, processed, and displayed on the single video monitor.

If users want to transfer a file from one computer to another that the computers are both connected to the KVM switch, there are two ways to practice. One is to transfer the file by internet (E-mail) or intranet; the other one is to transfer the file by an external storage, such as an USB flash memory. However, the aforementioned ways are neither easy to use nor convenient.

It is desirable, therefore, to provide a switch to allow for transferring files between associated computers connected to the switch.

### SUMMARY OF THE INVENTION

The primary objective of the resent invention is to provide a switch for transferring a file between associated computers. The switch comprises a first port set coupled a first computer; a second port set coupled to a second computer; a third port set coupled to the first and second computer; a first hub coupled to the first port set; a second hub coupled to the second port set; a data transferring unit coupled between the first hub and the second hub; a driving unit coupled to the first hub and the second hub and stored driving programs; a switching unit coupled to the first hub, second hub and the third port set; a control port set coupled to the switching unit; and a set of a keyboard, a cursor control device and a display unit coupled to the control port set; wherein the switching unit switches the set of keyboard, the cursor control device and the display unit coupled from the first computer to the second computer; wherein the data transferring unit registers a file from the first computer through the first hub and then transfers the file to the second computer through the second hub.

Another objective of the resent invention is to provide a switch for transferring a file between associated computers. The switch comprises a first port set coupled a first computer; a second port set coupled to a second computer; a third port set coupled to the first and second computer; a first hub coupled to the first port set; a second hub coupled to the second port set; a data transferring unit coupled between the first hub and the second hub; a first driving unit coupled to the first hub and stored driving programs; a second driving unit coupled to the second hub and stored the driving programs; a first switching unit including an USB host and a third hub, wherein the USB host is coupled to the first driving unit and the second driving unit; a second switching unit coupled to the third port set; a control port set coupled to the third hub and the second switching unit; and a set of a keyboard, a cursor control device and a display unit coupled to the control port set; wherein the first switching unit switches the keyboard and the cursor control device coupled from the first computer to the second computer and the second switching unit switches the displaying unit coupled from the first computer to the second computer; wherein the data transferring unit registers a file from the first computer through the first hub and then transfers the file to the second computer through the second hub.

Another yet embodiment of the present invention is to provide a switch for transferring a file between associated computers. The switch comprises a first port set coupled a first computer; a second port set coupled to a second computer; a third port set coupled to the first and second computer; a first USB PHY unit coupled to the first port set; a second USB PHY unit coupled to the second port set; a micro control unit coupled to the first USB PHY unit and the second USB PHY unit; an adopting unit including an USB host and a hub, wherein the USB host is coupled to the micro control unit; a video switching unit coupled to the third port set; a control port set coupled to the hub and the video switching unit; and a set of a keyboard, a cursor control device and a display unit coupled to the control port set; wherein the micro control unit switches the keyboard and the cursor control device coupled from the first computer to the second computer and the video switching unit switches the displaying unit coupled from the first computer to the second computer; wherein the micro control unit registers a file from the first computer through the first USB PHY unit and then transfers the file to the second computer through the second USB PHY unit.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates function blocks of the switch of the present invention.

FIG. 2 illustrates another function blocks of the switch of the present invention.

FIG. 3 illustrates another yet function blocks of the switch of the present invention.

### DETAILED DESCRIPTION OF THE INVENTION

The present invention relates generally to a switch module for enable a single user to control plurality of computers with a keyboard, monitor and cursor control device. There are many products for converting keyboard and cursor control device signals to USB signals. The concept is used in the switch module of present invention.

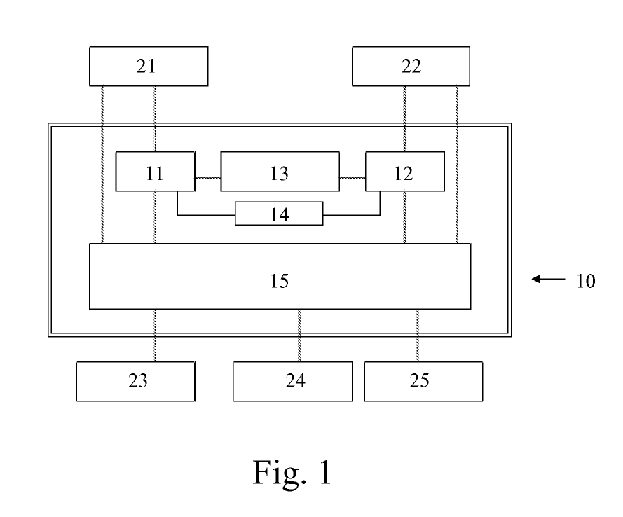

With reference to FIG. 1, this illustrates function blocks of the switch of the present invention. The switch 10 is a KVM (keyboard/video/cursor control device) switch for controlling a plurality of computers through one set of a keyboard 23, a cursor control device 24 and a display unit 25. The switch 10 comprises a first port set (not shown) coupled a first computer 21, a second port set (not shown) coupled to a second computer 22 and a third port set (not shown) coupled to the first and second computer 21, 22. The first and second port set receive control signals from the keyboard 23 and cursor control device 24 for controlling the first and second computer 21, 22, respectively. The third port set receives video signals from the first and second computer and transmits the video signals to the display unit 25. Both the first and second port set include USB interfaces for transmitting the control signals and the third port set includes DVI or HDMI interface for transmitting the video signals.

The switch 10 also comprises a first hub 11 coupled to the first port set, a second hub 12 coupled to the second port set, a data transferring unit 13 coupled between the first hub 11 and the second hub 22, a driving unit 14 coupled to the first hub 11 and the second hub 12 and stored driving programs, and a switching unit 15 coupled to the first hub 11, second hub 12 and the third port set. The switch 10 further comprises a control port set (not shown) coupled to the switching unit 15 and the set of keyboard 23, cursor control device 24 and display unit 25 coupled to the control port set. The driving programs stored in the driving unit 14 can drive the set of keyboard 23 and cursor control device 24 for controlling the first computer 21 and the second computer 22.

When a user wants to switch the control status from the first computer 21 to the second computer 22, the user can switch the switching unit 15 for coupling the set of keyboard 23, cursor control device 24 and display unit 25 from the first computer 21 to the second computer 22. If the user switches the switching unit 15 again, the control status will be returned to the first computer 21 from the second computer 22. If the user wants to transfer a file from the first computer 21 to the second computer 22, the user should copy the file at first, and then the file will be registered in the data transferring unit 13 through the first hub 11. After the switching unit 15 switches the set of keyboard 23 and cursor control device 24 coupled from the first computer 21 to the second computer 22 and the display unit coupled 25 from the first computer 21 to the second computer 22, the file registered in the data transferring unit 13 is transferred to the second computer 22 through the second hub 12. If the user wants to transfer other files from the first computer 21 to the second computer 22, most files will be registered in the data transferring unit 13 (according to the capacity of the data transfer unit) then transferred to the second computer 22 in turn. The data transferring unit 13 can be a FIFO (first in first out) memory. It is more convenient to transfer a file between computers by the switch 10 of the present invention than by internet (E-mail), intranet, or an external storage.

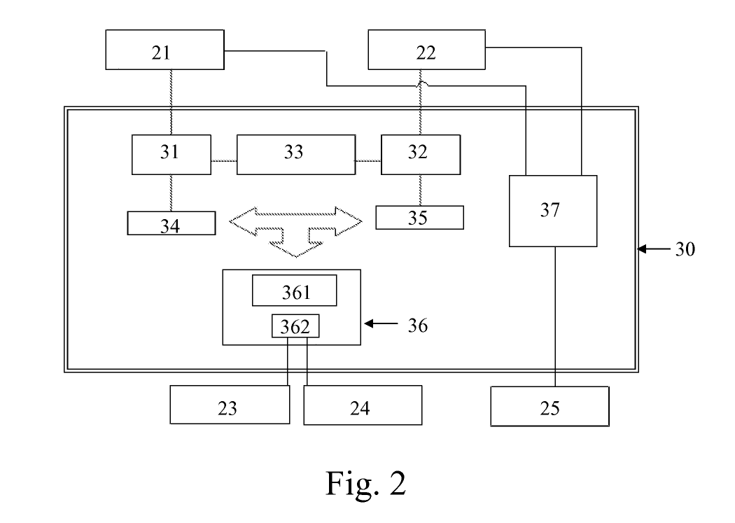

With reference to FIG. 2, this illustrates another function blocks of the switch of the present invention. The switch 30 comprises a first port set (not shown) coupled a first computer 21, a second port set (not shown) coupled to a second computer 22, a third port set (not shown) coupled to the first and second computer 21, 22, a first hub 31 coupled to the first port set, a second hub 32 coupled to the second port set, a data transferring unit 33 coupled between the first hub 31 and the second hub 32, a first driving unit 34 coupled to the first hub 31 and stored driving programs, a second driving unit 35 coupled to the second hub 32 and stored the driving programs and a first switching unit 36 including an USB host 361 and a third hub 362, wherein the USB host 361 is coupled to the first driving unit 34 and the second driving unit 35. The switch 30 also comprises a second switching unit 37 coupled to the third port set, a control port set (not shown) coupled to the third hub 362 and the second switching unit 37 and the set of keyboard 23, cursor control device 24 and display unit 25 coupled to the control port set. The first and second port set receive control signals from the keyboard 23 and cursor control device 24 for controlling the first and second computer 21, 22, respectively. The third port set receives video signals from the first and second computer and transmits the video signals to the display unit 25. Both the first and second port set include USB interfaces for transmitting the control signals and the third port set includes D-Sub, DVI or HDMI interfaces for transmitting the video signals.

The USB host 361 provides the third hub 362 with the function as a computer host for accepting other USB peripheral devices. Moreover, the USB host 361 and the third hub 362 can be integrated in one chip for saving the cost of the switch 30.

When a user wants to switch the control status from the first computer 21 to the second computer 22, the user can switch the first switching unit 36 and the second switching unit 37 for coupling the set of keyboard 23, cursor control device 24 and display unit 25 from the first computer 21 to the second computer 22, respectively. If the user switches the first and second switching unit 36, 37 again, the control status will be returned to the first computer 21 from the second computer 22. If the user wants to transfer a file from the first computer 21 to the second computer 22, the user should copy the file at first, and then the file will be registered in the data transferring unit 33 controlled by the user through the first hub 31. After the first switching unit 36 switches the set of keyboard 23 and cursor control device 24 coupled from the first computer 21 to the second computer 22 and the second switching unit 37 switches the display unit 25 coupled from the first computer 21 to the second computer 22, the file registered in the data transferring unit 33 can be transferred to the second computer 22 through the second hub 32. If the user wants to transfer other files from the first computer 21 to the second computer 22, most files will be registered in the data transfer unit 33 (according to the capacity of the data transfer unit) then transferred to the second computer in turn. The data transferring unit 33 can be a FIFO (first in first out) memory.

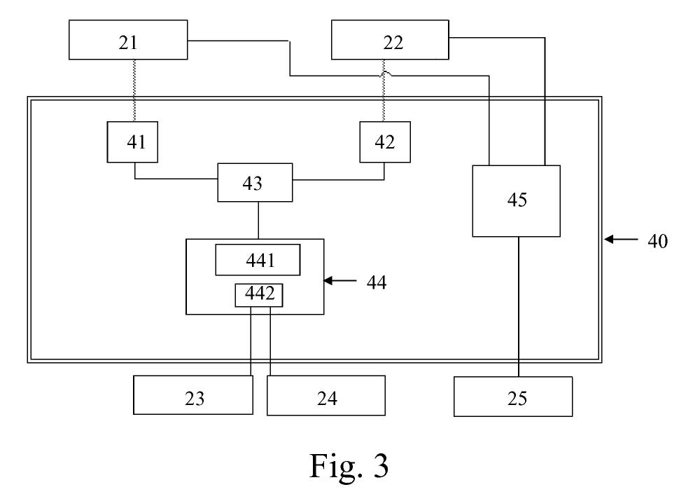

FIG. 3 illustrates another yet function blocks of the switch of the present invention. The switch 40 comprises a first port set (not shown) coupled a first computer 21, a second port set (not shown) coupled to a second computer 22; a third port set (not shown) coupled to the first and second computer 21, 22, a first USB PHY unit 41 coupled to the first port set, a second USB PHY unit 42 coupled to the second port set, a micro control unit 43 coupled to the first USB PHY unit 41 and the second USB PHY unit 42, and an adopting unit 44 including an USB host 441 and a hub 442, wherein the USB host 441 is coupled to the micro control unit 43. The switch 40 further comprises a video switching unit 45 coupled to the third port set, a control port set (not shown) coupled to the hub 442 and the video switching unit 45 and a set of keyboard 23, cursor control device 24 and display unit 25 coupled to the control port set. The first and second USB PHY unit 41, 42 are interfaces with USB plug-in terminal. Moreover, the USB host 441 and the hub 442 can be integrated in one chip and the first USB PHY unit 41 and the second USB PHY unit 42 can be integrated in one chip for saving the cost of the switch. Also, the first USB PHY unit 41 and the second USB PHY unit 42 and the micro control unit 43 can be integrated in one chip.

PHY (physical layer) is the lowest layer in computer network model for providing the mechanical, electrical and functional characteristics of the physical link in data transmission. Generally speaking, PHY ensures the original data transmitting on any physical medium. Therefore, the first USB PHY unit 41 and the second USB PHY unit 42 of the present invention ensure a file transferring from each other.

When a user wants to switch the control status from the first computer 21 to the second computer 22, the user can control the micro control unit 43 for coupling the set of keyboard 23 and cursor control device 24 the first computer 21 to the second computer 22 and the video switching unit 45 for coupling the display unit 25 from the first computer 21 to the second computer 22, and the video switching unit 45, respectively. If the user controls the micro control unit 43 again, the control status will be returned to the first computer 21 from the second computer 22. If the user wants to transfer a file from the first computer 21 to the second computer 22, the user should copy the file at first, and then the file will be registered in the micro control unit 43 through the first USB PHY unit 41 at first. After the micro control unit 43 switches the set of keyboard 23 and cursor control device 24 coupled from the first computer 21 to the second computer 22 and the video switching unit 45 switches the display unit 25 coupled from the first computer 21 to the second computer 22, the file registered in the micro control unit 43 can be transferred to the second computer through the second USB PHY unit 42.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

I claim:

1. A switch for transferring a file between associated computers comprising:
a first port set coupled a first computer;
a second port set coupled to a second computer;
a third port set coupled to the first and second computer;
a first hub coupled to the first port set;
a second hub coupled to the second port set;
a data transferring unit coupled between the first hub and the second hub;
a driving unit coupled to the first hub and the second hub and stored driving programs for driving peripheral devices coupled to the first hub and the second hub;
a switching unit coupled to the first hub, second hub and the third port set;
a control port set coupled to the switching unit; and
a set of keyboard, cursor control device and display unit coupled to the control port set;
wherein the switching unit switches the set of keyboard, the cursor control device and the display unit coupled from the first computer to the second computer;
wherein the data transferring unit registers a file from the first computer through the first hub and then transfers the file to the second computer through the second hub when the switching unit switches the set of keyboard, the cursor control device and the display unit coupled from the first computer to the second computer.

2. The switch according to claim 1, wherein the data transferring unit is a FIFO memory.

3. A switch for transferring a file between associated computers comprising:
a first port set coupled a first computer;
a second port set coupled to a second computer;
a third port set coupled to the first and second computer;
a first hub coupled to the first port set;
a second hub coupled to the second port set;
a data transferring unit coupled between the first hub and the second hub;
a first driving unit coupled to the first hub and stored driving programs for driving peripheral devices coupled to the first hub;
a second driving unit coupled to the second hub and stored the driving programs;
a first switching unit including an USB host and a third hub, wherein the USB host is coupled to the first driving unit and the second driving unit;
a second switching unit coupled to the third port set;
a control port set coupled to the third hub and the second switching unit; and
a keyboard, a cursor control device and a display unit coupled to the control port set;
wherein the first switching unit switches the keyboard and the cursor control device coupled from the first computer to the second computer and the second switching unit switches the displaying unit coupled from the first computer to the second computer;
wherein the data transferring unit registers a file from the first computer through the first hub and then transfers the file to the second computer through the second hub when the first switching unit switches the keyboard and the cursor control device coupled from the first computer to the second computer and the second switching unit switches the displaying unit coupled from the first computer to the second computer.

4. The switch according to claim 3, wherein the data transferring unit is a FIFO memory.

5. The switch according to claim 3, wherein the second switching unit is a video switching unit.

6. The switch according to claim 3, wherein the USB host and the third hub can be integrated in a chip.

7. A switch for transferring a file between associated computers comprising:
a first port set coupled a first computer;
a second port set coupled to a second computer;
a third port set coupled to the first and second computer;
a first USB PHY unit coupled to the first port set;
a second USB PHY unit coupled to the second port set;
a micro control unit coupled to the first USB PHY unit and the second USB PHY unit;
an adopting unit including an USB host and a hub, wherein the USB host is coupled to the micro control unit;
a video switching unit coupled to the third port set;
a control port set coupled to the hub and the video switching unit; and
a keyboard, a cursor control device and a display unit coupled to the control port set;
wherein the micro control unit switches the keyboard and the cursor control device coupled from the first computer to the second computer and the video switching unit switches the displaying unit coupled from the first computer to the second computer;
wherein the micro control unit registers a file from the first computer through the first USB PHY unit and then transfers the file to the second computer through the second USB PHY unit when the micro control unit switches the keyboard and the cursor control device coupled from the first computer to the second computer and the video switching unit switches the displaying unit coupled from the first computer to the second computer.

8. The switch according to claim 7, wherein the USB host and the third hub can be integrated in a chip.

9. The switch according to claim 7, wherein the first USB PHY unit and the second USB PHY unit can be integrated in a chip.

10. The switch according to claim 7, wherein the first USB PHY unit, the second USB PHY unit and the micro control unit can be integrated in a chip.
